(19) United States
(12) Patent Application Publication
(10) Pub. No.: US 2012/0081904 A1
(43) Pub. Date: Apr. 5, 2012

(54) Lamp

(76) Inventor: Alex Horng, Kaohsiung (TW)

(21) Appl. No.: 12/961,613

(22) Filed: Dec. 7, 2010

(30) Foreign Application Priority Data
Oct. 5, 2010 (TW) 099133921

(51) Int. Cl. F21V 29/00

(52) U.S. Cl. 362/294

(57) ABSTRACT

A lamp comprises a heat sink, including a base having a first side and a second side, wherein the first side has a fixing portion; a lighting module mounted on the second side of the base; a cooling fan mounted to the fixing portion of the heat sink, including an impeller and a driving circuit board for propelling the rotating of the impeller; and a power circuit board installed between the base of the heat sink and the cooling fan, wherein the power circuit board is electrically coupled with the lighting module.

### BACKGROUND OF THE INVENTION

1. Field of the Invention

The present invention relates to a lamp and, more particularly, to a lamp capable of efficiently dissipating heat.

2. Description of the Related Art

With reference to FIG. 1, disclosing a conventional lamp 9 as shown in U.S. Pat. No. 7,575,346, the conventional lamp 9 comprises a housing 91, a heat sink 92, a lighting module 93 and a cooling fan 94. The housing 91 has a light-transparent portion 911 and an electrically coupled portion 912, which are separately placed on opposite edges of the housing 91. Moreover, the inner top of the housing 91 has a power circuit board 913 electrically coupled to the electrically coupled portion 912. The heat sink 92, placed on the inner part of the housing 91, has a plurality of fins 921 to surround a compartment 922. The lighting module 93, coupling to the bottom of the heat sink 92, electrically couples to the power circuit board 913 and allows the light shining through the light-transparent portion 911. The cooling fan 94, set inside the compartment 922 for the heat sink 92, has a driving circuit board 941 electrically coupled to the power circuit board 913.

When the electrically coupled portion 912 is charged, the power circuit board 913 propels the illumination of the lighting module 93 and generates heat. Meanwhile, the power circuit board 913 also propels the cooling fan 94 via the driving circuit board 941, in order to assist in the heat-dissipation of the heat sink 92.

However, the conventional lamp 9 above has some disadvantages in practical use: firstly, heat-dissipation of the heat sink 92 and the cooling fan 94 is limited due to their structure; secondly, the volume of the conventional lamp 9 is cumbersome and unable to miniaturize due to the allocation of the power circuit board 913. Mainly, the heat sink 92 and the cooling fan 94 are applied to the operating lighting module 93 for cooling. Yet, the heat-dissipation of the power circuit board 913 is dramatically restricted and poor in efficiency because of the placements of the heat sink 92 and the cooling fan 94, and also due to additional heat generated by the operating power circuit board 913, Furthermore, for proper allocation, the housing 91 of the conventional lamp 9 not only needs enough space for containing the heat sink 92 and the lighting module 93, but also needs additional space for the power circuit board 913, which makes the volume of the conventional lamp 9 bulky and irreducible.

### SUMMARY OF THE INVENTION

The primary objective of the present invention is to improve the disadvantages of the conventional lamp and to provide a lamp which can effectively and efficiently dissipate heat.

The secondary objective of the present invention is to provide a lamp which can be easily miniaturized and reducible in size.

A lamp comprises a heat sink, including a base having a first side and a second side, wherein the first side has a fixing portion; a lighting module mounted on the second side of the base; a cooling fan mounted to the fixing portion of the heat sink, including an impeller and a driving circuit board for propelling the rotating of the impeller; and a power circuit board installed between the base of the heat sink and the cooling fan, wherein the power circuit board is electrically coupled with the lighting module.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a side cross-sectional view of a conventional lamp.

FIG. 2 shows an exploded diagram of a lamp according to a first embodiment of the present invention.

FIG. 3 shows a side cross-sectional view of the lamp according to the first embodiment of the present invention.

FIG. 4 shows an exploded diagram of a lamp according to a second embodiment of the present invention.

FIG. 5 shows a side cross-sectional view of the lamp according to the second embodiment of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions conforming to specific force, weight, strength, and similar requirements will likewise be within the skill of the art after the following teachings of the present invention have been read and understood.

### DETAILED DESCRIPTION OF THE INVENTION

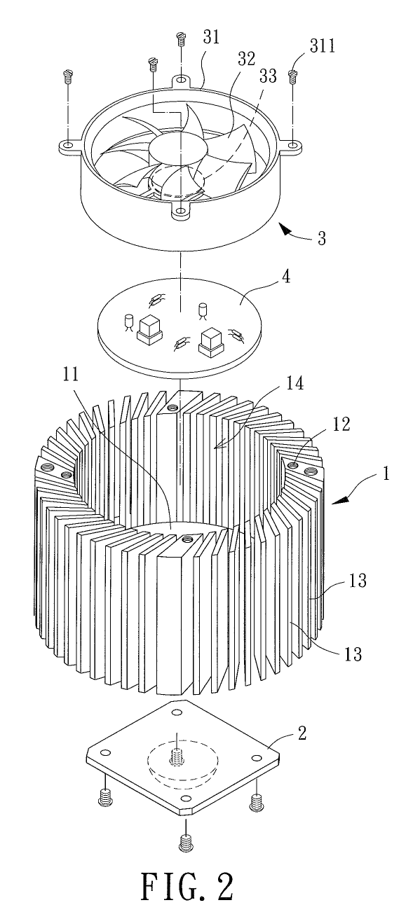

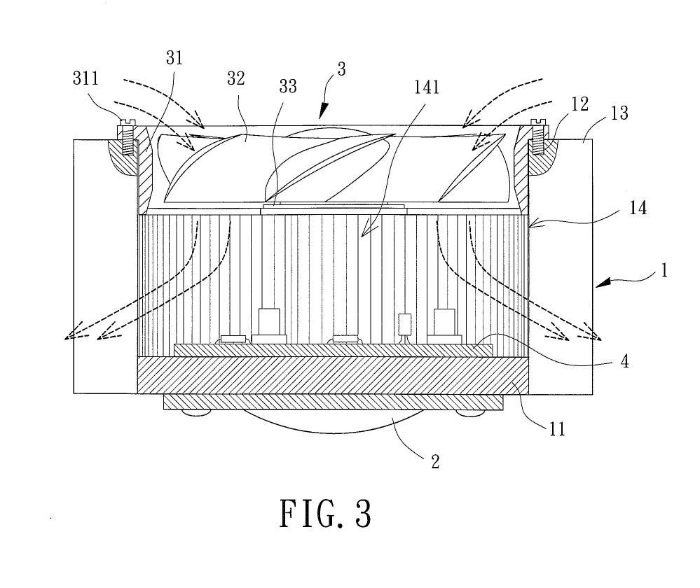

Referring to FIGS. 2 and 3, in accordance with the first embodiment of the present invention, the lamp comprises a heat sink 1, a lighting module 2, a cooling fan 3 and a power circuit board 4, wherein the heat sink 1 couples with the lighting module 2, the cooling fan 3 and the power circuit board 4.

The heat sink 1, consisting of any heat-conductive materials, has a base 11 with a first side and a second side, wherein the first side has at lease one fixing portion 12. The fixing portion 12 can be any structure for fastening and fixing the cooling fan 3. In the embodiment of the present invention, the heat sink 1 has a plurality of fins 13 and a compartment 14. The plurality of fins 13 are separately arranged in a circular order on the first side of the base 11 and surround the compartment 14. The fixing portion 12 is formed on a top edge of at least one of the fins 13 in the present invention. Furthermore, the fixing portion 12 can be a plurality of orientated pores.

The lighting module 2 couples to the second side of the base 11 of the heat sink 1 via any possible fixing method, such as fastening by screws or gum. The lighting module 2 can be a light emitting diode (also known as LED), bulb or any member which can emit light as it is electrified.

The cooling fan 3 has a frame 31, an impeller 32 and a driving circuit board 33. The cooling fan 3 can be fixed on the fixing portion 12 of the heat sink 1 via the frame 31. In the embodiment of the present invention, the frame 31 is stably fastened on the fixing portion 12 of the heat sink 1 with a plurality of fixing elements, such as screws or plugs. The impeller 32 is rotatably installed on the internal edge of the frame 31. The driving circuit board 33 propels the rotation of the impeller 32 for conducting the air-flow to dissipate heat.

The power circuit board 4 is set inside the compartment 14 of the heat sink 1, between the base 11 and the cooling fan 3. The power circuit board 4 couples to the lighting module 2 for driving the luminosity of the lighting module 2, wherein the power circuit board 4 can couple to the top of the base 11, the inner or other position of the compartment 14. In the embodiment of the present invention, the power circuit board 4 mounts to the first side of the base 11 via a heat-conducting insulation member, such as an insulating plate or insulating glue, for the sake of directly conducting the heat from the power circuit board 4 to transmit to the heat sink 1 with the heat-conducting insulation member. Furthermore, an airflow space forms between the top of the power circuit board 4 and the bottom of the cooling fan 3 to provide enough space for airflow and to prevent against the collision between the rotating cooling fan 3 and the power circuit board 4. Additionally, the power circuit board 4 and the driving circuit board 33 of the cooling fan 3 are integrated into a single printed circuit board installed between the base 11 and the cooling fan 3. The description above is easily understandable to people who are familiar with the technique in this art.

In practical use, the power circuit board 4 of the lamp in the present invention is coupled to a general power supply and charges the cooling fan 3, as well as the lighting module 2, for emitting light. In this situation, a significant amount of heat generating from the operating lighting module 2 and power circuit board 4 will transmit to the plurality of fins 13 via the base 11. Accordingly, with the coordination of the cooling fan 3, external air currents can flow into the compartment 14 and effectively dissipate the heat generated from the lighting module 2 and the power circuit board 4.

The lamp of the present invention is characterized in that, by disposing the power circuit board 4 between the base 11 of the heat sink 1 and the cooling fan 3, the heat generated by the lighting module 2 and the power circuit board 4 may be expelled from the lamp when the cooling fan 3 draws the external air into the compartment 14. Therefore, the lamp of the present invention is dramatically efficient in heat-dissipation. Moreover, the lamp of the present invention is sufficient for miniaturizing the volume, which makes the design of the lamp light.

Furthermore, by coupling the power circuit board 4 on the base 11 via the heat-conducting insulation member, the heat generated by the lighting module 2 and the power circuit board 4 may be delivered to the plurality of fins 13 via the heat conduction effect of the base 11. In this way, the lamp of the present invention is highly effective in heat-dissipation, so as to prolong the service life of the lamp.

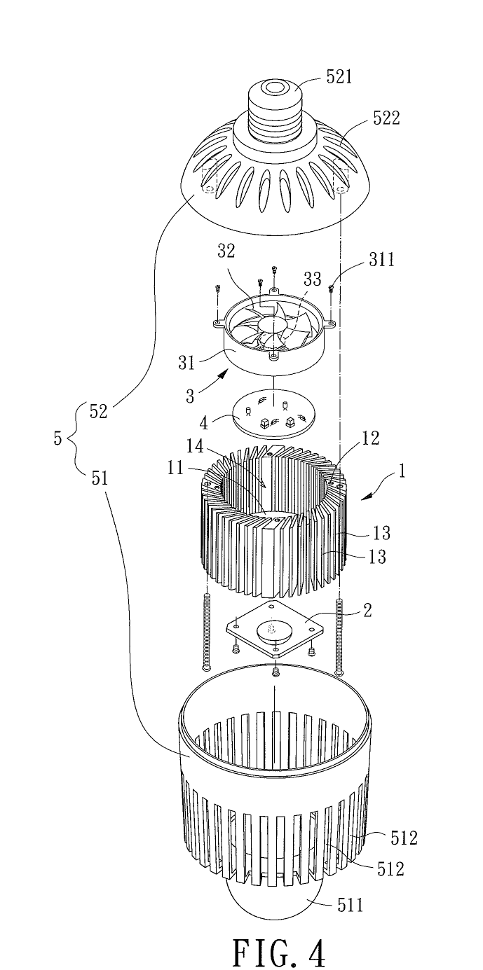

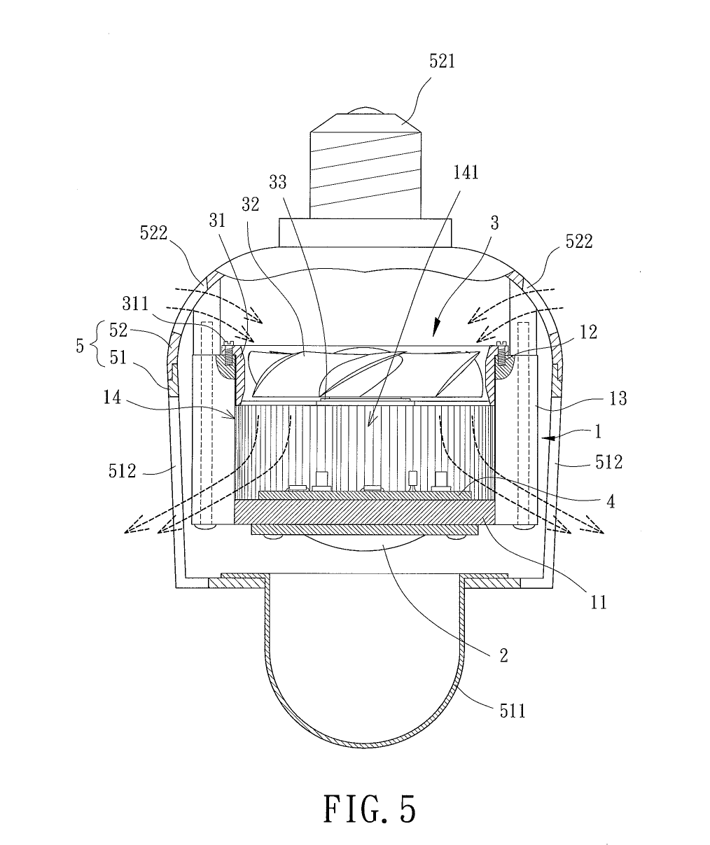

Referring to FIGS. 4 and 5, in accordance with the second embodiment of the present invention and in contrast to the first embodiment, the lamp further comprises a housing 5 for containing the heat sink 1, the light module 2, the cooling fan 3 and other relating members, which can be a hollow case or can consist of a plurality of modular members. In the embodiment of the present invention, the housing 5 consists of a first housing 51 and a second housing 52.

The first housing 51 has two ends, with one end having a light-transparent portion 511 and the other end having a detachable structure that can be assembled to and disassembled from the second housing 52. The first housing 51 has an air-outlet portion 512.

The second housing 52 also has two ends, with one end having an electrically coupled portion 521 and the other end having a detachable structure that can be assembled to and disassembled from the first housing 51. Moreover, the housing 52 also comprises an air-inlet portion 522. In the embodiment, the air-outlet portion 512 and the air-inlet portion 522 are a plurality of slots penetrating through the external surface and internal surface of the first housing 51 and the second housing 52 respectively.

In actual fabrication, the lighting module 2, the cooling fan 3 and the power circuit board 4 are first set on the heat sink 1, followed by integrating the heat sink 1 with the second housing 52 and making the power circuit board 4 electrically coupled to the electrically coupled portion 521. In this situation, the cooling fan 3 will be close to the air-inlet portion 522. Then, the second housing 52 is integrated with the first housing 51 which makes the lighting module 2 facing the light-transparent portion 511 of the first housing 51, so as to successfully assemble the lamp of the present invention.

In practical use, the lighting module 2 of the lamp in the present invention is charged by a general power supply by coupling the electrically coupled portion 521 and a lamp holder on walls, ceilings or desks, to allow the light of the lighting module 2 shining through the light-transparent portion 511 and provide the electric power to the cooling fan 3. In this situation, the heat generating from the operating lighting module 2 and power circuit board 4 will directly transmit to the plurality of fins 13 via the base 11. Accordingly, with the coordination of the cooling fan 3, external air currents are flowed into the compartment 14 and effectively dissipate the heat generating from the lighting module 2 and the power circuit board 4 to the air-outlet portion 512. Hence, an efficient heat-dissipation of the lamp can be achieved in the present invention.

In comparison with the lamp of the first embodiment comprising the lighting module 2, the cooling fan 3, the power circuit board 4 and the heat sink 1, the lamp of the second embodiment further comprises the housing 5 to contain the assembled heat sink 1, in order to provide a protection for component members, and also to provide a better flow-circuit for heat-dissipation according to the allocation of the air-inlet portion 522 and the air-outlet portion 512.

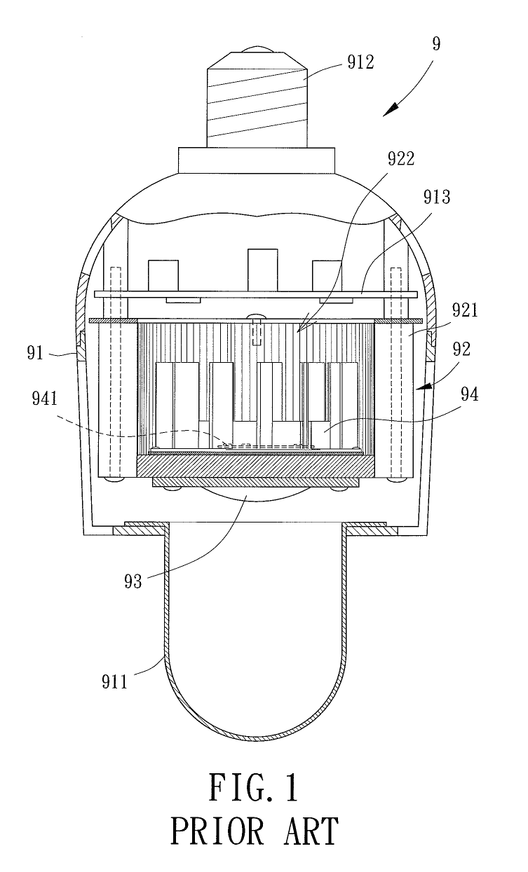

Through the present invention, it is sufficient to effectively promote heat-dissipation, as well as the service life of the lamp due to the allocation of the power circuit board 4 between the base 11 of the heat sink 1 and the cooling fan 3. In this way, the heat generating from the operating lighting module 2 and the power circuit board 4 can be effectively transmitted to external space, with the cooling fan 3 conducting external air currents to flow into the compartment 14. Therefore, compared to the lamp shown in the FIG. 1, the lamp of the present invention is sufficient to miniaturize its size due to the allocation of the power circuit board 4 inside the compartment 14. Accordingly, the future design of the lamp will become be lighter.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A lamp comprising:
a heat sink, including a base having a first side and a second side, wherein the first side has a fixing portion;
a lighting module mounted on the second side of the base;
a cooling fan mounted to the fixing portion of the heat sink, including an impeller and a driving circuit board for propelling the rotating of the impeller; and
a power circuit board installed between the base of the heat sink and the cooling fan, wherein the power circuit board is electrically coupled with the lighting module.

2. The lamp as claimed in claim 1, wherein an airflow space is formed between the power circuit board and the cooling fan.

3. The lamp as claimed in claim 1, wherein the power circuit board couples with the base via a heat-conductive insulating plate or insulating glue.

4. The lamp as claimed in claim 2, wherein the power circuit board couples with the base via a heat-conductive insulating plate or insulating gel.

5. The lamp as claimed in claim 1, wherein the base has a plurality of fins on the first side, and the fixing portion is formed on an edge of at least one of the fins.

6. The lamp as claimed in claim 2, wherein the base has a plurality of fins on the first side, and the fixing portion is formed on an edge of at least one of the fins.

7. The lamp as claimed in claim 5, wherein the plurality of fins defines a compartment and the power circuit board is installed inside the compartment.

8. The lamp as claimed in claim 6, wherein the plurality of fins defines a compartment and the power circuit board is installed inside the compartment.

9. The lamp as claimed in claim 1, wherein the power circuit board and the driving circuit board are integrated into a single printed circuit board.

10. The lamp as claimed in claim 2, wherein the power circuit board and the driving circuit board are integrated into a single printed circuit board.

11. The lamp as claimed in claim 1, further comprising a housing containing the heat sink, the lighting module, the cooling fan and the power circuit board.

12. The lamp as claimed in claim 2, further comprising a housing containing the heat sink, the lighting module, the cooling fan and the power circuit board.

13. The lamp as claimed in claim 11, wherein the housing has an air inlet and an air outlet, and both the air inlet and the air outlet penetrating through the external surface and the internal surface of the housing.

14. The lamp as claimed in claim 12, wherein the housing has an air inlet and an air outlet, and both the air inlet and the air outlet penetrating through the external surface and the internal surface of the housing.
